(19) United States
(12) Patent Application Publication
(10) Pub. No.: US 2004/0181572 A1
(43) Pub. Date: Sep. 16, 2004

(54) System for providing information related to a location using keyword name and method thereof

(75) Inventors: Pan-Jung Lee, Seoul (KR); Dong-Man Lee, Daejeon-city (KR); Kee-Cheon Kim, Seoul (KR); Eun-Cheon No, Koyang-city (KR); Chang-Hun Lee, Seoul (KR); Dong-Geon Lee, Seoul (KR); Jae-Pil Yu, Seoul (KR); Ji-Weon Choi, Seoul (KR); Jin-Hyun Bae, Seoul (KR)

Correspondence Address: Ari M. Bai, Greensfelder, Hemker & Gale, P.C., Suite 2000, 10 South Broadway, St. Louis, MO, 63102, US

(73) Assignee: NETPIA DOT COM, INC.

(21) Appl. No.: 10/776,753

(22) Filed: Feb. 11, 2004

(30) Foreign Application Priority Data
Aug. 11, 2001 (KR) 2001/48477
Dec. 18, 2001 (WO) PCT/KR01/02201

(51) Int. Cl. G06F 15/16

(52) U.S. Cl. 709/200

(57) ABSTRACT

Disclosed is a system and method for providing location information using a keyword name on the Internet. When a keyword name from a user terminal is transmitted through a mobile communication network system, the user's location information is requested to the mobile communication network system, and an Internet address is searched based on the location information and keyword name. Contents provided from a contents providing server having the Internet address are transmitted to the user terminal, and when the format of the contents is not available to the user terminal, the contents are converted into the format available to the user terminal, and provided to the user terminal. Hence, the user may automatically detect the user's location, access a web page matched with the user's present location without assigning a specific location, and receive the contents without modifying the network configuration under the wireless Internet environment supporting different languages.

### BACKGROUND OF THE INVENTION

(a) Field of the Invention

The present invention relates to a location information providing system using a keyword name, and a method thereof. More specifically, the present invention relates to a system and method for using a keyword name to provide a user's current location information on a wireless network that uses different languages.

(b) Description of the Related Art

People across the world have come to share various categories of information through the Internet, a huge network, because of the rapid development of network technologies.

Various types of services including an information transmission service, a search service, an information providing service, and an interactive service are provided through the Internet, and the information providing service among them has a Windows format and generally uses an application service for providing hypertext-type information. In the information providing service, text strings are linked to additional text, files, images, moving pictures, and voice data, and when a user clicks each text string, corresponding text, files, and images for displaying more detailed information are provided to the user's computer.

As transmission speeds of mobile communication services have recently kept up with those of cable services, the above-described services have been implemented on the wireless Internet. The users use wireless terminals such as a mobile phone, a PDA, a notebook, and other mobile networks to access an information providing site to receive information, goods, and services, and to execute transactions.

However, since the users are required to undergo various stages (accessing, selecting menus, and inputting keywords) for obtaining desired information, it is difficult for the users to quickly receive desired information, and the services generate complex processes.

Also, when attempting to access a predetermined service-providing system on the Internet, the users need to know a corresponding domain name, and since the domain name includes a combination of English letters following a predetermined rule, it is relatively more difficult for Korean, Japanese, and Chinese people who do not speak English to memorize the domain names, it is not easy for them to input domain names through a wireless terminal, and it takes a great deal of time to input desired domain names and file names.

To overcome the problem, services providing menus for a wireless terminal user to access a predetermined system on the wireless Internet are offered, so the wireless terminal user can select a corresponding menu without additionally inputting a domain name, and be connected to the system on the Internet, but the services are problematically restricted to the systems that cooperate with mobile service providers to which the terminals are registered.

Methods for supporting data services on the wireless Internet include the WAP (wireless application protocol), the ME (mobile explorer), and the I-mode that is used in Japan.

The WAP represents standardized communication protocols of methods for applying mobile terminals such as cellular phones and pagers to electronic mail, the web, and news groups through Internet access. The WAP uses the WML (wireless markup language) to provide data.

The ME, a wireless Internet browser developed by Microsoft in 1999, was developed in order to use the conventional HTML (hypertext markup language) contents, differing from the standards of the WAP and the HDML (handheld device markup language), and the ME is very compatible. The WAP requires a WAP gateway to convert the HTML contents into a wireless Internet environment, but the ME-based contents do not require a gateway.

The I-Mode is a packet-based mobile phone service provided by NTT DoCoMo, a wireless technology leader in Japan. Differing from most of the major companies in the wireless technology industry field, NTT DoCoMo's I-Mode intentionally uses the CWML (compact wireless markup language) which is a simplified version of the HTML, rather than the WML of the WAP.

Recently, services for providing location information on the basis of the user's location under the wireless Internet data service environment have been executed, but they are restricted to certain languages, and hence, they are not provided to users who have a terminal that supports a different language.

Further, the wireless Internet data service environments require security for data transmission. In detail, when a user's terminal adopts the WAP, severe security problems may be generated among the user, a mobile communication service provider's network, and a contents provider. Security setting is necessary for a client and a server in the case of security-requiring services including financial services and electronic commerce. In this instance, since WTLS (wireless transport layer security) is used between a client and a gateway, and the SSL (secure socket layer) is used between a gateway and a server to perform a security function, the gateway may monitor the security setting between the client and the server, which may become a fatal problem if a gateway is installed in a region that is unreliable for a WAP contents service provider.

### SUMMARY OF THE INVENTION

It is an object of the present invention to allow a user to input desired location information using a corresponding keyword name without undergoing a process including an access to a corresponding web page when the user attempts to receive information through the wireless Internet, thereby enabling the user to easily and quickly receive various types of location information.

It is another object of the present invention to allow a user to receive the user's location information under wireless Internet service environments that provide different languages.

It is still another object of the present invention to securely transmit data under the wireless Internet environment.

In one aspect of the present invention, a location information system connected to a plurality of contents providing servers through a network, for processing a keyword name provided from a user terminal through a mobile communication network, comprises: a keyword name database for matching an Internet address on the network, a keyword name, and location information, and storing them; a processing server for requesting a user's location information from the mobile communication network system when the keyword name provided from the user terminal is transmitted through the mobile communication network system; and a keyword name server for searching the keyword name database to find an Internet address on the basis of the location information and the keyword name provided from the mobile communication network system, and providing the Internet address to the processing server, wherein the processing server receives contents from a contents providing server having the Internet address and provides the contents to the user terminal.

The processing server comprises: a contents requester for requesting the contents from the contents providing server having the Internet address, and receiving corresponding contents; and a contents converter for converting the contents into a format available to the user terminal, and providing the converted contents to the mobile communication network system to provide the corresponding contents to the user terminal.

The contents converter determines whether the format of the contents provided by the contents providing server is matched with the format available to the user terminal, and when they are not matched, the contents converter converts the contents into a format available to the user terminal.

The mobile communication network system measures the location of the user terminal according to a location information request by the processing server, and provides corresponding location information to the processing server.

The system further comprises a proxy server for securing the keyword name provided by the user terminal and providing the secured keyword name to the processing server, and when the keyword name provided from the mobile communication network system is input not through the proxy server, the processing server transmits an error message to the mobile communication network system so that the user terminal may provide the keyword name through the proxy server.

In another aspect of the present invention, a method for providing location information using a keyword name in a system connected to a user terminal through a mobile communication network system comprises: requesting the user's location from the mobile communication network system when the keyword name provided from the user terminal is transmitted through the mobile communication network system; searching a keyword name database to find an Internet address on the basis of the location information provided from the mobile communication network system and the keyword name; and receiving contents from a contents providing server having the Internet address, and providing the contents to the user terminal.

The method further comprises: determining whether the format of the received contents is matched with the format available to the user terminal; converting the contents into the format available to the user terminal and providing them to the user terminal when the formats are not matched; and providing the contents to the user terminal without conversion when the formats are matched.

The method further comprises: determining whether the keyword name provided from the user terminal is input through a proxy server installed in the system; and transmitting an error message to the mobile communication network system when the keyword name is input not through the proxy server so that the user terminal may provide the keyword name through the proxy server.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIGS. 1(a) and 1(b) show a method for providing location information using a keyword name according to a preferred embodiment of the present invention;

FIG. 2 shows a configuration of a system for providing location information using a keyword name according to a preferred embodiment of the present invention;

FIG. 3 shows a flowchart of a method for providing location information using a keyword name according to a preferred embodiment of the present invention;

FIG. 4 shows a contents-converting process according to a preferred embodiment of the present invention; and

FIG. 5 shows a security-reinforced network configuration from a location-information providing system using a keyword name according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

In a preferred embodiment of the present invention, a location-based keyword name (in particular, a Korean character keyword domain) service is provided. The location-based keyword name service is generated by combining the LBS (location based service) provided on a mobile communication network with a Korean character keyword domain search service. The LBS provides a subscriber's location generated by using various LDAs (location determination algorithms), and provides a corresponding geographical service. The LBS includes a travel information service, a hotel/restaurant search service, and a location detection service in addition to the wireless E911 service, which is a mobile communication service for detecting a location of a mobile communication subscriber who sends an emergency call and for effectively coping with the subscriber's crisis situation.

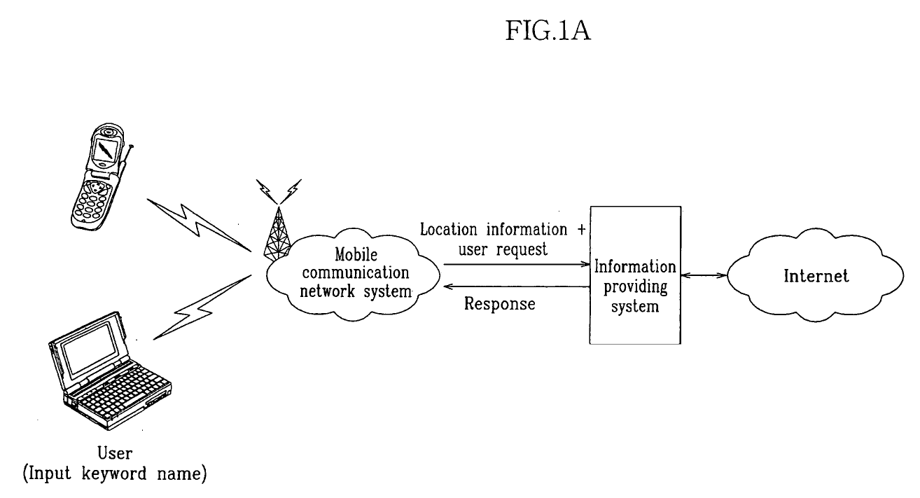

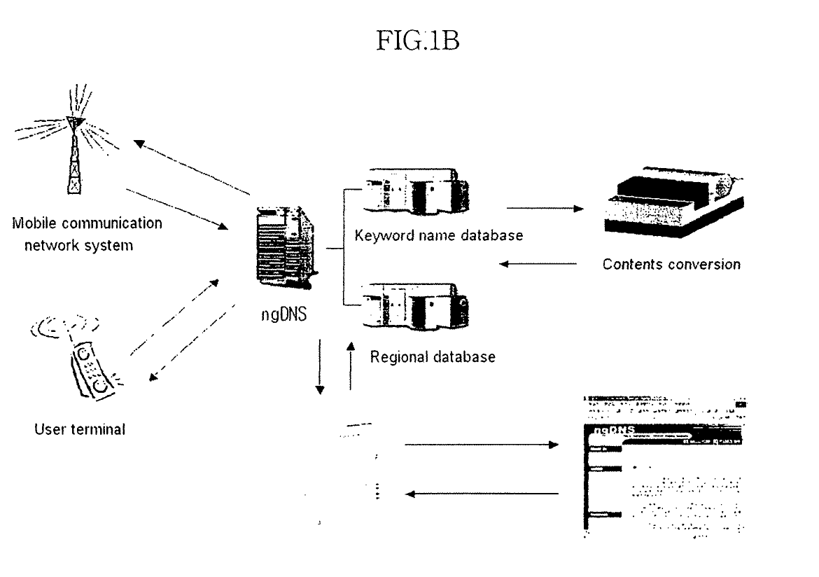

FIGS. 1(a) and 1(b) show a concept of an information providing system for performing a location-based keyword name service according to a preferred embodiment of the present invention.

A network configuration as shown by FIG. 1(a) is provided so as to realize a location information providing system using a keyword name according to the preferred embodiment of the present invention. As shown in FIGS. 1(a) and 1(b), in order for a mobile terminal user to use the service, the user uses a mobile communication network system that provides the service to the user to access a web page of the information providing system, and the corresponding web page of the information providing system is converted by a gateway in the mobile communication network system into a document format acceptable to the mobile terminal, and the converted data are transmitted to the user's terminal. When the user uses the information providing system to inquire about a Korean character keyword name, the information providing system receives the user's location information from the mobile communication network system to allow the user to access another web page that is on the user's location base.

Accordingly, the information providing system comprises: an LIR (location information requester) module for inquiring of the mobile communication network system about the user's location information, and bringing information; an HTTP client module for providing inquiries to an HTTP contents provider, and receiving contents; and a contents conversion module for converting the received contents into predetermined contents appropriate for the user.

A configuration and an operation of the information providing system using a keyword name according to the preferred embodiment of the present invention will be described in detail.

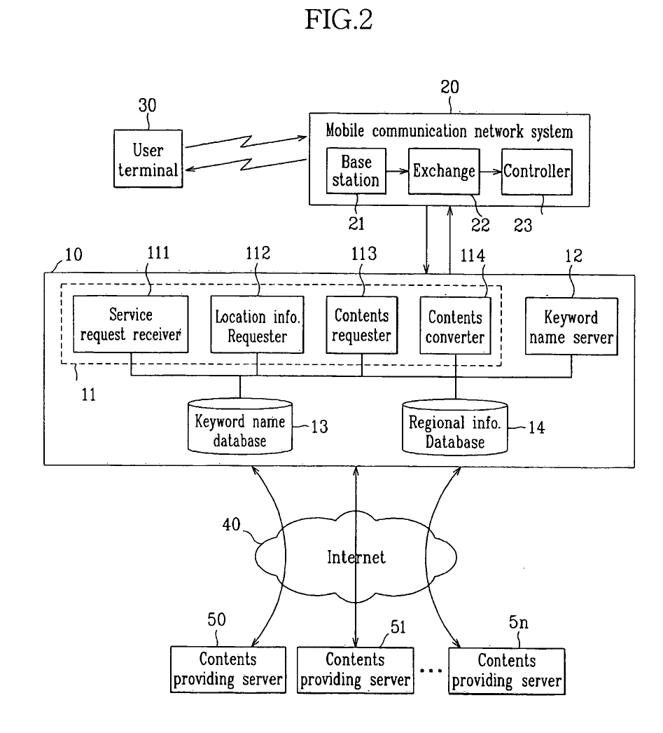

FIG. 2 shows a configuration of the location-information providing system using a keyword name according to the preferred embodiment of the present invention.

As shown, the location information providing system 10 using a keyword name (referred to as the information providing system hereinafter) is connected to a plurality of user terminals 30 through a mobile communication network system 20, and is connected to a plurality of contents providing servers 50 through 5n through the Internet 40 (including a future network).

The user terminals 30 include wireless terminals for accessing the mobile communication network system 20, receiving data, and processing the data.

The mobile communication network system 20 provides a data service request provided by the user terminal 30 to the information providing system 10 to be processed, measures user location information according to a request by the information providing system 10, and provides the same to the information providing system 10. In detail, the mobile communication network system 20 comprises: a base station 21 for receiving signals from a mobile terminal within a corresponding cell, that is, a user terminal; a controller 23 for detecting the corresponding mobile terminal's location according to the signals output to the base station 21, and providing corresponding location information to the information providing system 10; and an exchange 22 for transmitting and receiving signals between the base station 21 and the controller 23.

The controller 23 inquires of the information providing system 10 about a keyword name provided by the user terminal 30, and provides measured user location information to the information providing system 10 so that the user terminal 30 may be connected to a predetermined web page matched with the keyword name according to the user location information. Also, the controller 23 processes contents according to a wireless Internet service environment to provide the contents to the user terminal 30. For example, in the case of providing a wireless communication service on the basis of the WAP, the controller 23 installs a WAP gateway in the network architecture of the controller 23 to convert the HTML-formatted contents provided by a contents provider (a contents providing server) on the Internet into WML contents available to the user terminal 30, and provide the same to the user.

There are two methods for measuring the user's location information. The first one is a network-based solution that uses CDMA mobile communication networks, and the second one is a handset-based solution that uses one of a GPS (global positioning system) receiver and a 3G terminal with a built-in GPS receiver to detect the user's location.

The method for measuring the user location on the basis of the CDMA network includes a method for receiving signals transmitted to an MS (mobile station) from a BS (base station), and comparing intensities of the signals with a statistical probability distribution to measure a location; a direction finding system method for measuring an AOA (angle of arrival) of the signals transmitted to the MS from the BS to find a location of the MS; a TOA (time of arrival) method for measuring a radio wave transmission time to find a corresponding location; and it further includes a ranging position location system method for using a distance between an MS and a BS to find a location in the like manner of the TDOA (time difference of arrival) method for using a relative difference of a radio wave arrival times from two BSs.

The method for measuring the user location on the basis of the CDMA network advantageously measures the user location without an additional device, but it has difficulty in accurately determining the user location. On the contrary, the GPS method enables accurate location-finding, and provides a more precise service through the accurate location, but it requires use of one of an additional GPS receiver and a 3G terminal with a built-in GPS receiver.

The user's location may be measured using the above-described various methods, and in particular, since it is sufficient for the location information providing system according to the preferred embodiment of the present invention to determine a rough location of a user on the move, that is, a cell-unit location, a CDMA-network-based location-measuring technique may be used instead of the GPS-based location measuring technique.

The information providing system 10 enables the user terminal 30 accessed through the mobile communication network system 20 to be connected to a predetermined web page matched with a keyword name, and in particular, it selects a web page corresponding to the keyword on the basis of the user's location information. In addition, the information providing system 10 may provide regional information corresponding to the keyword name on the basis of location information.

For this, the information providing system 10 comprises: a keyword name database 13 for storing information needed for providing the users' location information; a regional information database 14; a processing server 11 for providing a keyword name's web page access service to the user terminal 30 according to the location information on the basis of the information stored in the databases 13 and 14; and a keyword name server 12.

The regional information database 14 stores, per region, various categories of information matched with the keyword name. For example, the regional information database 14 stores various kinds of information (including location information and introduction) on district offices which belong to respective regions, such as Yoksam-dong, Sokchon-dong, and Shinsa-dong in correspondence to the keyword name of “District office.” Also, it stores information on pizza delivery shops for the respective regions such as Yoksam-dong, Sokchon-dong, and Shinsa-dong in correspondence to the keyword name of “Pizza.”

The keyword name database 13 stores at least one keyword name corresponding to all Internet IP addresses, and additionally stores URL information corresponding to each keyword name. For example, it stores a keyword name of “Netpia” matched with the IP address of “210.103.175.66” and stores URL information of “netpia.net” matched with “Netpia.”

In particular, in the preferred embodiment of the present invention, an IP address or URL information is stored corresponding to the keyword name and the user's location information so that the user may be automatically linked to a web page matched with the keyword name including a regional feature according to the user's location information. For example, the IP address “120.130.280.33” may be stored corresponding to “Ward office (a keyword name). Kangnam-ku (user location information).” As a result, “User location information+Keyword name” functions as a domain name.

Also, the keyword name database 13 may store an IP address or URL information corresponding to a keyword name that does not include the regional feature, and in the subsequent preferred embodiment, a method for providing location information on the basis of the keyword name including a regional feature will be described.

Further, the information providing system may comprise a member information database for storing information on a plurality of users registered as members for receiving the location information service.

The processing server 11 provides location information matched with the keyword name to the user terminal 30 on the basis of the information stored in the databases 13 and 14, and performs a web function so that the user terminal 30 may be connected to the system through the Internet 40 or the mobile communication network system 20. The processing server 11 comprises a service request receiver 111, a location information requester 112, a contents requester 113, and a contents converter 114.

The service request receiver 111 receives a service request from the mobile communication network system 20, and processes it. In detail, the service request receiver 111 receives inquiries including the keyword name from the mobile communication network system 20, and transmits them to another unit, and it comprises a web page used for receiving the request. It is more effective to make the web page in one of the WML, the M-HTML, and the c-HTML document formats rather than the HTML document format.

When the inquiry caused by receiving a service request from the mobile communication network system 20 includes a keyword name, the location information requester 112 requests user location information from the mobile communication network system 20, and provides the received location information and the keyword name to the keyword name server 12 to search a web page address.

The contents requester 113 accesses the corresponding web page and brings contents on the basis of the web page address corresponding to the user's location information and the keyword name provided by the keyword name server 12. In order to not use a method for bringing the contents from the web page requested by the user and transmitting them to the user, the processing server of the information providing system transmits the searched web page address to the user so that the user may directly access the corresponding web page, or the processing server transmits the web page address to the gateway in the mobile communication network system so that the gateway may directly bring the web contents. However, the first method reduces service quality because of direct access of the user's terminal, and the second method is impossible because the gateway must be modified in the mobile communication network system. Therefore, in the information providing system according to the preferred embodiment of the present invention, the processing server brings the contents from the web page matched with the user's location information and the keyword name, and provides them to the user so that the service quality may be improved and the information providing service may be performed without modifying the mobile communication network system.

The contents converter 114 converts the contents of the web page requested by the user into predetermined contents available by the user's terminal. The gateway of the mobile communication network system may perform the contents conversion, but in this case, the contents are required to be converted into a format available by the gateway. For example, when the user terminal uses the ME, and the web page requested by the user provides WML contents or c-HTML contents, the present gateway may partially understand the WML or the c-HTML contents, and discard information, and vice versa. Therefore, in order to provide a more improved service to the user without information loss in the preferred embodiment of the present invention, the information providing system converts the contents into those desired by the user, and then transmits them.

The keyword name server 12 combines the keyword name input by the user with user location information provided by the mobile communication network system to search an address of the web page desired by the user. In detail, the keyword name server 12 searches the keyword name database 13 to find an address of the corresponding web page on the basis of the keyword name and the location information provided by the location information requester 112 of the processing server 11, and provides the web page address to the contents requester 113 of the processing server 11 to thereby bring the contents as described above.

Accordingly, the keyword name server may search the web page address on the basis of the keyword name and the user location information, and without being restricted to this, the processing server may be realized to perform the search function.

In this instance, respective components 121 through 124 are operated in the web server 12, and without being restricted to this, they may be implemented into respective individual servers to process corresponding functions.

The contents providing servers 50 through 5n connected to the Internet 40 provide various contents, and in particular, HTML-formatted contents.

The keyword name according to the preferred embodiment of the present invention includes domain names including native languages (Korean language, English language, and foreign languages other than the English language) matched with all web page addresses registered on the Internet, numbers, and symbols, and it particularly includes actual names such as company names, firm names, and service tables, and names with regional features such as ward offices, theaters, and district offices.

An operation of the location information providing system using a keyword name according to the preferred embodiment of the present invention will now be described in detail.

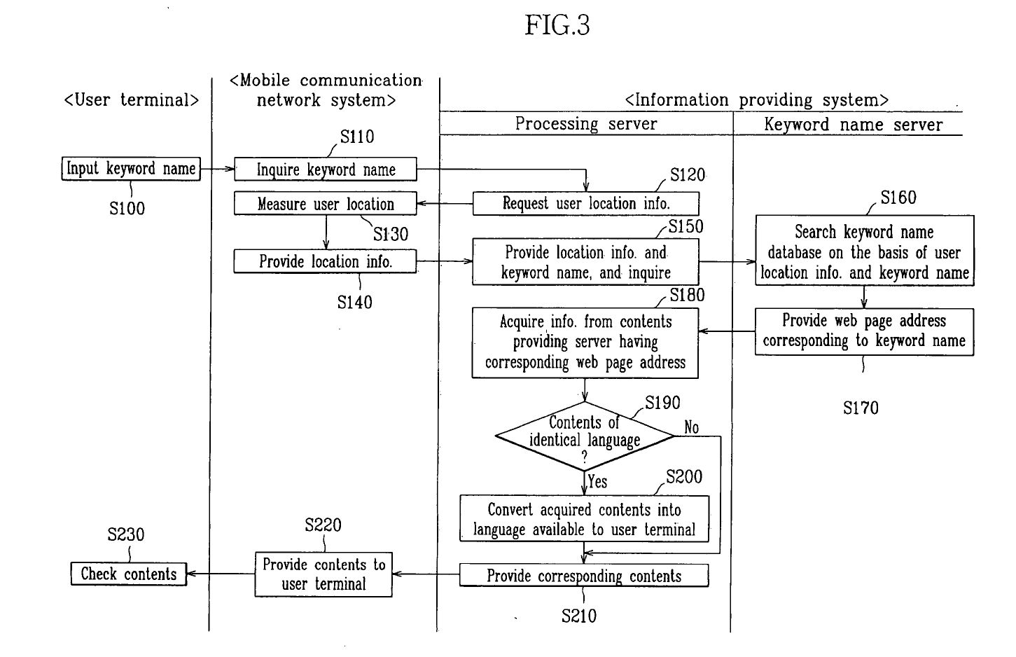

FIG. 3 shows a flowchart for a location-information providing method using a keyword name according to the preferred embodiment of the present invention.

When the user uses the terminal to drive a browser for wireless Internet access and inputs an access word into an access word input window on the browser, the input access word is provided to the mobile communication network system 20 in step S100. The controller 23 of the mobile communication network system 20 transmits the access word, provided by the base station 21 in the cell where the user terminal 30 belongs, to the information providing system 10 to request data in step S110.

When inquiries including the access word are transmitted to the information providing system 10 from the mobile communication network system 20, the location information requester 112 of the processing server 11 determines that the access word is a keyword name, and requests user location information from the mobile communication network system 20 in step S120 so as to provide web page information according to the user location information. In this instance, the mobile communication network system 20 or the information providing system may determine whether the access word provided from the user terminal is a keyword name, and provide location information depending on the keyword name.

The controller 23 of the mobile communication network system 20 uses one of the above-described various location measuring methods, measures the user terminal's location, that is, a user location, and provides corresponding location information to the information providing system 10 in steps S130 and S140.

The location information requester 112 of the information providing system 10 provides the access word input by the user, that is, the keyword name and the user location information to the keyword name server 12, and requests a corresponding web page address in step S150 when receiving the user location information from the mobile communication network system 20.

The keyword name server 12 searches the keyword name database 13 on the basis of the user location information and the keyword name, searches a web page address stored corresponding to the keyword name and the user's location information, and provides the same to the contents requester 113 of the processing server 11 in steps S160 and S170.

Accordingly, the contents requester 113 accesses the web page of the contents providing server 50 matched with the web page address provided by the keyword name server 12, and brings corresponding contents. For example, the contents requester 113 requests the contents corresponding to the web page address from the corresponding contents providing server 50, and receives the contents in step S180.

The contents requester 113 provides the contents to the contents converter 114 so that they may be provided to the user terminal 30. The contents converter 114 selectively converts the contents brought from the corresponding web page, and provides the converted contents to the mobile communication network system 20 so that they may be provided to the user terminal 30.

The contents converter 114 converts the contents into a predetermined format available to the user terminal and provides the converted contents to the mobile communication network system 20 when the format of the corresponding contents is not available to the user terminal, and the contents converter 114 provides the contents to the mobile communication network system 20 as they are when the format of the corresponding contents is available to the user terminal, in steps S190 through S210.

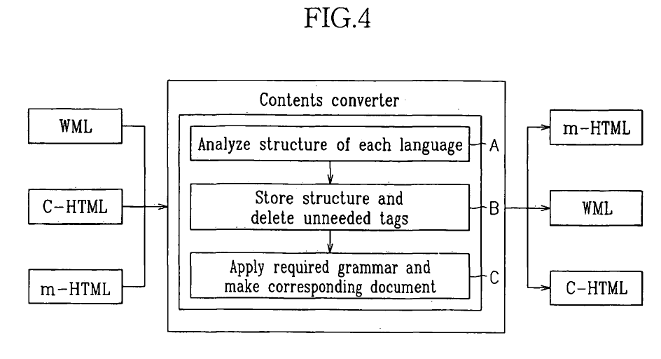

FIG. 4 shows a contents converting process.

Except in the case when a contents provider uses the same language, a subsequent conversion process is performed when any types of languages are input.

First, the contents converter 114 analyzes the configuration of the input contents in A, separates the analyzed configuration from general text to store them in B, deletes unneeded contents, applies grammar of the desired language, and reconfigures the contents in C.

As described above, since the preferred embodiment supports the languages of the various wireless Internet contents including the WAP, the I-mode, and the ME, when a WAP-type terminal requests I-mode contents, the c-HTML-formatted contents of the I-mode service are converted into the WAP's WML to be transmitted to the terminal. The ME may be also translated into different languages in the like manner, and accordingly, the user may receive different contents using a terminal that supports a single language.

The contents converter 114 provides the converted or unconverted contents to the mobile communication network system 20, and the mobile communication network system 20 transmits the corresponding contents to the user terminal 30 in steps S220 and S230.

For example, when the user who uses the 011 mobile phone service accesses the n-top mobile service in a car that passes through the Kangnam area to be thus connected to the information providing system, and inputs a word “Ward office,” the user terminal is automatically connected to the homepage of the Kangnam ward office on the basis of the user's present location.

Therefore, the user may easily receive the contents of the desired web page and check them according to the user's location. Also, the user may easily receive contents of different languages including the WAP, the I-mode, and the ME under the wireless Internet environments.

When the user receives information through the wireless Internet or does electronic commerce, security such as information leakage prevention is required.

Hence, in order to solve the security problem generated when the user terminal uses the WAP, the WAP enterprise proxy server for reinforcing the security function of the WAP gateway is used.

The enterprise proxy server for providing an End-to-End-to-End security function is installed in a reliable third area by a contents provider, and not in the mobile communication service provider area, so as to perform the data conversion process, and hence, fatal security cancellation problems generated in the mobile communication service provider area are solved. That is, by installing the WAP enterprise proxy server in the information providing system, security between the information providing system and users of the location-based name search service that supports at least one language may be reinforced.

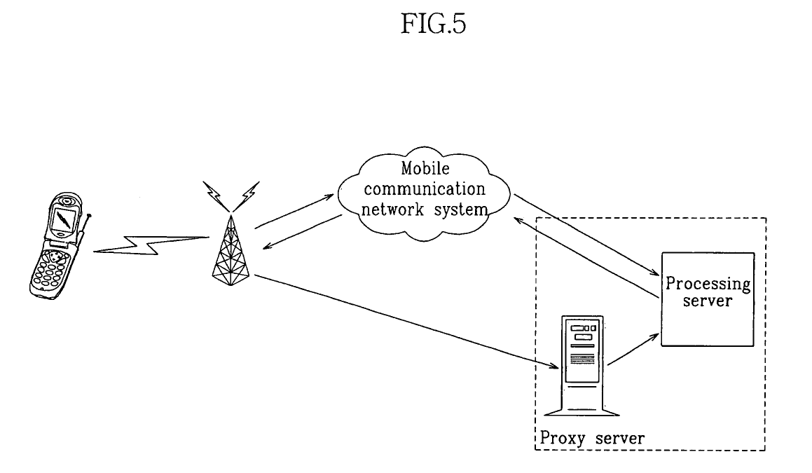

FIG. 5 shows a security-reinforced network configuration in the location information system using a keyword name according to the preferred embodiment of the present invention on the basis of the above-described concept.

As shown, when the user requests the service, the corresponding request item is transmitted to the processing server of the information providing system through the gateway of the mobile communication network system. Since the request is transmitted through the gateway in an area that is unreliable to the processing server of the information providing system, the processing server transmits an error message (http 300) to the user terminal so as to receive the request through a reliable gateway. Accordingly, the user terminal considers not the gateway in the mobile communication network system but the enterprise proxy server to be reliable by the information providing system as a default gateway, and requests the service again. The dotted portion in FIG. 5 represents an area considered reliable by the information providing system.

Therefore, the processing server of the information providing system processes the request transmitted through the reliable enterprise proxy server as described above so that the user may receive appropriate information according to the present location.

The location information providing system using a keyword name may be applied to electronic mail executed on the Internet, the FTP (file transfer protocol), and the telnet as well as the WWW (world wide web).

Further, as described above, in addition to providing information on the web page matched with the keyword name provided by the user terminal, the location information system may additionally provide regional information according to the present user location. That is, when the user is in Kangnam-ku and inputs the keyword name “Ward office,” homepage information on the Kangnam-ku ward office is transmitted to the user terminal, and additional regional information including district offices and theaters located in Kangnam-ku may be concurrently provided on the basis of the information stored in the regional information database.

As described, when a user desires to find location information on the network, the location information system allows the user to directly input a keyword name of the desired web page without undergoing a process of accessing the corresponding web page, so that the user may quickly access the desired web page.

In particular, the location information system automatically detects the user's location when the user does not designate a specific location, thereby enabling the user to access a suitable web page matched with the user's present location.

Also, by selectively converting the contents provided by a contents provider into a format available to the user terminal, the location information system easily provides the contents without additional modification of the network configuration under the wireless Internet environments that support different languages.

That is, it is possible to detect the mobile communication user's present location, and it is also possible to provide a location-based keyword name search service for automatically translating at least one language on the basis of the user's present location. For example, when a user who is currently in Sungbook-ku inputs “District office” in the terminal, the homepage of the Sungbook district office is downloaded to the user's terminal. When conventional services that independently use a language used by one of the WAP, the ME, and the I-mode request the contents of different languages, no response is generated. However, when the location-based Korean character keyword domain search service for supporting automatic translation of two languages according to the preferred embodiment of the present invention is used, communication between a terminal and a server each using a different language is enabled. That is, when a user who possesses a WAP terminal inputs “District office,” it is requested as the WML used by the WAP, and the contents of the c-HTML that is the language of the I-mode and those of the m-HTML that is the language of the ME in addition to the documents of the WML are serviced.

Further, information is safely and reliably provided under the wireless Internet environment, thereby improving security.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A location information system connected to a plurality of contents providing servers through a network, for processing a keyword name provided from a user terminal through a mobile communication network, comprising:
a keyword name database for matching an Internet address on the network, a keyword name, and location information, and storing them;
a processing server for requesting a user's location information from the mobile communication network system when the keyword name provided from the user terminal is transmitted through the mobile communication network system; and
a keyword name server for searching the keyword name database to find an Internet address on the basis of the location information and the keyword name provided from the mobile communication network system, and providing the Internet address to the processing server, wherein the processing server receives contents from a contents providing server having the Internet address and provides the contents to the user terminal.

2. The system of claim 1, wherein the processing server comprises:
a contents requester for requesting the contents from the contents providing server having the Internet address, and receiving corresponding contents; and
a contents converter for converting the contents into a format available to the user terminal, and providing the converted contents to the mobile communication network system to provide the corresponding contents to the user terminal.

3. The system of claim 1, wherein the contents converter determines whether the format of the contents provided by the contents providing server is matched with the format available to the user terminal, and when they are not matched, the contents converter converts the contents into a format available to the user terminal.

4. The system of claim 1, wherein the mobile communication network system measures the location of the user terminal according to a location information request by the processing server, and provides corresponding location information to the processing server.

5. The system of claim 1, wherein the system further comprises a proxy server for securing the keyword name provided by the user terminal and providing the secured keyword name to the processing server, and when the keyword name provided from the mobile communication network system is input not through the proxy server, the processing server transmits an error message to the mobile communication network system so that the user terminal may provide the keyword name through the proxy server.

6. The system of claim 1, wherein the keyword name includes Korean characters.

7. A method for providing location information using a keyword name in a system connected to a user terminal through a mobile communication network system, comprising:
requesting the user's location from the mobile communication network system when the keyword name provided from the user terminal is transmitted through the mobile communication network system;
searching a keyword name database to find an Internet address on the basis of the location information provided from the mobile communication network system and the keyword name; and
receiving contents from a contents providing server having the Internet address, and providing the contents to the user terminal.

8. The method of claim 7, further comprising:
determining whether the format of the received contents is matched with the format available to the user terminal;
converting the contents into the format available to the user terminal and providing them to the user terminal when the formats are not matched; and
providing the contents to the user terminal without conversion when the formats are matched.

9. The method of claim 7, further comprising:
determining whether the keyword name provided from the user terminal is input through a proxy server installed in the system; and
transmitting an error message to the mobile communication network system when the keyword name is input not through the proxy server so that the user terminal may provide the keyword name through the proxy server.
